(19) United States
(12) Patent Application Publication
(10) Pub. No.: US 2015/0077256 A1
(43) Pub. Date: Mar. 19, 2015

(54) RETAIL SECURITY TAG

(71) Applicant: DUBOIS LIMITED, Corby (GB)

(72) Inventor: Sean G. MADDOX, Farnsfield (GB)

(73) Assignee: DUBOIS LIMITED, Corby (GB)

(21) Appl. No.: 14/032,126

(22) Filed: Sep. 19, 2013

(51) Int. Cl. G08B 13/24

(52) U.S. Cl. CPC G08B 13/2431
USPC 340/572.1

(57) ABSTRACT

A security tag or device for use with a product package. The security tag has an optical sensor that is calibrated to an intensity of ambient radiation (or light, if any) within the package interior (e.g., from a source outside the package). The optical sensor can be aligned with an opening in the package to detect light. After calibration, a controller is used with optical sensor to determine changes in detected ambient radiation within the package, and rates of those changes. The security tag has an alarm adapted to provide an alert when a predetermined change in ambient radiation within a package is detected. Alternatively, the security tag can have an arm, with the optical sensor thereon, that extends from its housing for insertion into the package. A receiving opening can optionally be provided in the package for receipt of the arm.

### BACKGROUND

1. Technical Field

This present invention relates generally to devices for holding and enclosing products and to security devices or tags for use with such devices to substantially prevent or deter theft. More particularly, it relates to a container or package for a product having a removable security device with an optical sensor.

2. Description of Related Art

Many types of containers are known for consumer products, including cosmetics, such as perfumes and makeup, electronic devices, such as cellular phones, MP3 players, cameras, navigation systems, as well as other types of products that are housed in different types of packaging.

A problem encountered with such known apparatuses is the removal and theft of a product for sale from the apparatus within a store selling such products. The product is usually provided within a container which is provided with a security tag which triggers an alarm if the container is taken out of the store without the tag first being removed or rendered inactive by staff in the store. However, it has been found that thieves may be able to remove a product from the packaging, thereby thwarting the use of a security tag. They then leave the empty container on the shelf and leave the store with the product outside of the packaging without triggering the alarm system.

There are also other ways thieves can try to avoid the existing security measures taken by stores selling products. Security tags are often provided on the products and thieves may, for instance, remove or disable these. The term “security tag” is used herein to refer to any form of component which triggers an alarm if it or the package or product is tampered with.

For these reasons, many stores only display empty containers and when a customer has made a selection, the staff retrieves the relevant product from a secure cupboard or safe and places it in the container for the customer. However, this takes additional time and requires an additional secure storage place for the products. It also increases the risk that the wrong product may be put in the container, especially if the staff is busy. The stores would also prefer for the products to be held within the boxes on display as this is more appealing to a potential customer than an empty box (and has been shown to significantly increase sales). There is therefore a desire within the trade to be able to display product containers with the relevant product already held therein; such a practice being known as “live” storage within the trade.

Prior art devices for increasing the security of such containers tend to be bulky and expensive. One known form of device comprises a “keeper” in the form of a robust casing or frame which fits around, or partially around, the exterior of the container and is locked in a closed position so it is impossible to open the container without first unlocking and removing the keeper. Such keepers are difficult to handle, substantially increase the size of the product (often increasing the size of the product by 30% or more and so occupying more shelf space). They also detract from the aesthetics of the product, may conceal some of the artwork on the exterior or front of the container and considerably reduce the attractiveness of the product to a potential customer. Additionally, stores have to maintain a variety of different sized keepers, as the packaging around the product varies in size. Further, if a product or its packaging is redesigned to be physically larger, a store may have to replace all of their existing keepers with larger keepers, increasing the retailer's expenses of selling the products.

Some products may utilize a “spider” type security device that typically includes an alarm that is secured on the outside of a container by a system of cables that are lockable to the container. The spider security device typically is adapted to provide an audible alarm if the container is removed from a predetermined area of a retail environment. However, a skilled thief may be able to remove a spider type security device by cutting the cable, or unlocking the cables and removing the spider. The cables can also be slid off the package through manipulation, which allows the spider to be removed. Further, the spider security device also increases the shelf space required to store a product, as the spider security device is attached to the outside of the container. Further, the spider security device detracts from the aesthetics of the container by covering at least a portion of the container.

WO97/02569 describes another form of security device in which one edge of the container is inserted into a channel shaped keeper which fits over the edge of the product and extends at least part way over opposite external faces of the container to prevent the container from being opened. Such a keeper is still a relatively complex and expensive item, which adds significantly to the external dimensions of the container, reduces the attractiveness of the container to a potential customer and prevents the container from being stood on its bottom edge. For these reasons, this type of device has not been widely used.

U.S. Pat. No. 7,404,484, which is incorporated by reference in its entirety herein, describes a security device that effectively secures a media disc within a container. The security device may pass through a side of the container and interacts with a disk engaging mechanism in order to both secure the container in a closed position and inhibits removal of the media disk by inhibiting actuation of the disk engaging mechanism. However, such a security device may not cooperate with a security system in a retail environment, and such a security device is not adapted for use with containers for products other than media disks.

Similarly, U.S. Pat. No. 7,315,253, which is incorporated by reference in its entirety herein, describes a security device that includes a transponder for use with a security system in a retail environment. However, such a security device may be defeated by a thief that tampers with the container or is able to remove the security device, or is able to prevent communication from the security system in the retail environment. Further, such a security device is not adapted for use with containers for products other than media disks.

However, existing containers and security devices do not adequately alert a retailer when a container is being tampered with in order to steal a product inside of the container in order to thwart the security system of the retail environment. Therefore, a need exists for a product container having an improved security device.

### SUMMARY

One aspect of the disclosure provides a security tag. The security tag for a package comprising: a housing with a battery therein; an optical sensor on the housing configured to detect an intensity of ambient radiation within the package; a circuit connecting the battery and the optical sensor; an alarm or indicator further connected to the circuit and adapted to provide an alert; and a controller configured to control the alarm or indicator based on detections by the optical sensor, wherein the optical sensor is calibrated upon attachment of the housing to the package based on ambient radiation detected within the package, and wherein the optical sensor is configured to detect the changes of intensity of the ambient radiation within the package to activate via the controller the alarm or indicator and provide the alert.

Another aspect of this disclosure provides a security tag. The security tag includes: a housing with a battery therein and an arm extending from the housing and spaced therefrom. The arm is configured for insertion into a package. An optical sensor is provided on the arm and configured to detect an intensity of ambient radiation within the package. A circuit is also provided in the tag and is configured to connect the battery and the optical sensor such that the optical sensor is activated for detection. An alarm or indicator is connected to the circuit and adapted to provide an alert. A controller is configured to control the alarm or indicator based on detections by the optical sensor. The optical sensor is calibrated according to the detection of ambient light radiation within the package upon its activation, and is configured to detect the changes of intensity of the ambient radiation within the package after its calibration to activate via the controller the alarm or indicator and provide the alert.

According to yet another aspect, a product package is provided. The product package includes: a plurality of walls configured to contain contents in an interior cavity; at least one of the plurality of walls of the product package configured to be moved between (a) an open position allowing access to contents inside the interior cavity of the product package via an opening and (b) a closed position substantially preventing access to the contents within the interior cavity therein by closing the opening; and a security device being removably connected to the product package. The security device has a housing with a battery, and an optical sensor on the housing positioned and configured to detect an intensity of ambient radiation in the interior cavity of the product package. A circuit of the security device is configured to connect the battery and the optical sensor for detection. The security device further includes an alarm or indicator adapted to provide an alert. A controller is configured to control the alarm or indicator based on detections by the optical sensor. The optical sensor is calibrated according to the intensity detection of ambient radiation within the interior cavity of the product package upon its activation. The optical sensor is configured to detect a change of intensity of ambient radiation within the interior cavity after its calibration to activate the alarm or indicator via the controller and provide the alert.

In still yet another aspect, there is provided a method for operating a security tag attached to a package. The security tag has a battery, an optical sensor configured to detect an intensity of ambient radiation within the package, a circuit configured to connect the battery and the optical sensor such that the optical sensor is activated for detection, an alarm or indicator adapted to provide an alert, and a controller configured to control the alarm or indicator based on detections by the optical sensor. The method includes: activating the optical sensor by connecting the battery and the optical sensor via the circuit; determining the ambient radiation within the package with the sensor; determining changes in intensity of the ambient radiation; and calibrating the optical sensor to the determined ambient radiation. The optical sensor is configured to detect the changes of intensity of the ambient radiation within the package to activate the alarm or indicator via the controller and provide the alert.

Other features and advantages of the present disclosure will become apparent from the following detailed description, the accompanying drawings, and the appended claims.

### BRIEF DESCRIPTION OF THE DRAWINGS

FIG. 1 illustrates a top perspective view of a security tag in accordance with an embodiment of this disclosure.

FIG. 2 illustrates a cross sectional view taken along line 2-2 of the security tag in FIG. 1, in accordance with an embodiment.

FIGS. 3 and 4 illustrate alternate top perspective views of parts inside a housing of the security tag according to an embodiment.

FIG. 5 illustrates a bottom perspective view, in partial cross section, of parts inside the housing of the security tag, in accordance with an embodiment.

FIG. 6 illustrates perspective views of an exemplary product package in an open and closed position for use with a security tag in accordance with this disclosure.

FIGS. 7 and 8 illustrate a first side and a second side, respectively, of a blank, configured to form the product package of FIG. 6 in accordance with an embodiment.

FIG. 9 illustrates an alternate perspective view of the product package of FIG. 6 formed from the blank of FIGS. 7 and 8 in an open position.

FIG. 10 illustrates an alternate perspective view of the product package in a closed position.

FIG. 11 illustrates a perspective view of a security tag aligned for insertion into a product package disclosed herein according to an embodiment.

FIG. 12 illustrates a detailed, cross sectional view of the security tag attached to product container of FIG. 6 in accordance with an embodiment.

FIG. 13 illustrates a top perspective view of a security tag on a package in accordance with an embodiment of this disclosure.

FIG. 14 illustrates a cross sectional view taken along line 14-14 of the security tag in FIG. 13, in accordance with an embodiment.

### DETAILED DESCRIPTION

Generally, the present disclosure is for a product package or product container for a retail product, such as a digital camera, MP3 player, cellular phone and/or other consumer electronics products, gift cards, rewards cards, exchangeable cards, reusable and/or reloadable cards, and the like. “Package” and “container” are used herein interchangeably throughout, it should be understood that both are designed to package items for sale in retail environments. Similarly, such terms should not be limiting and could also be called a case or structure. Furthermore, the terms “interior” and “exterior,” “inner” and “outer,” and “inside” and “outside” are used throughout the description on a reference basis, and may be interchangeable, unless additionally stated. Such terms are not meant to be limiting. Any depiction or description, including size, shape, design, etc. of the packages, sensor, arms, and security devices herein is exemplary only and not intended to be limiting in any way.

The description and Figures herein disclose a security device or “security tag” (as referred to herethroughout) with an optical sensor (or optical sensing system) for detecting ambient radiation within, and any change thereof, the interior of the package. A radio signal can be sent to indicate the detected change, and/or an alarm (optional) or other indicator (optional) can be activated to provide an alert of unauthorized entry, e.g., upon detection of a [predetermined amount of] change in the ambient radiation inside the package by the optical sensor and a controller.

The illustrations include multiple embodiments of a product package having a plurality of walls configured to contain contents therein upon assembly (e.g., when formed from a blank). Each of the walls has an interior surface and an exterior surface. At least one of the walls is also configured to be moved between an open position allowing access to contents in the product package via an opening and a closed position substantially preventing access to the contents therein by closing the opening. The security tag can be secured or attached to such a product package, with its optical sensor aligned with an aperture or inserted through the wall(s) of the package.

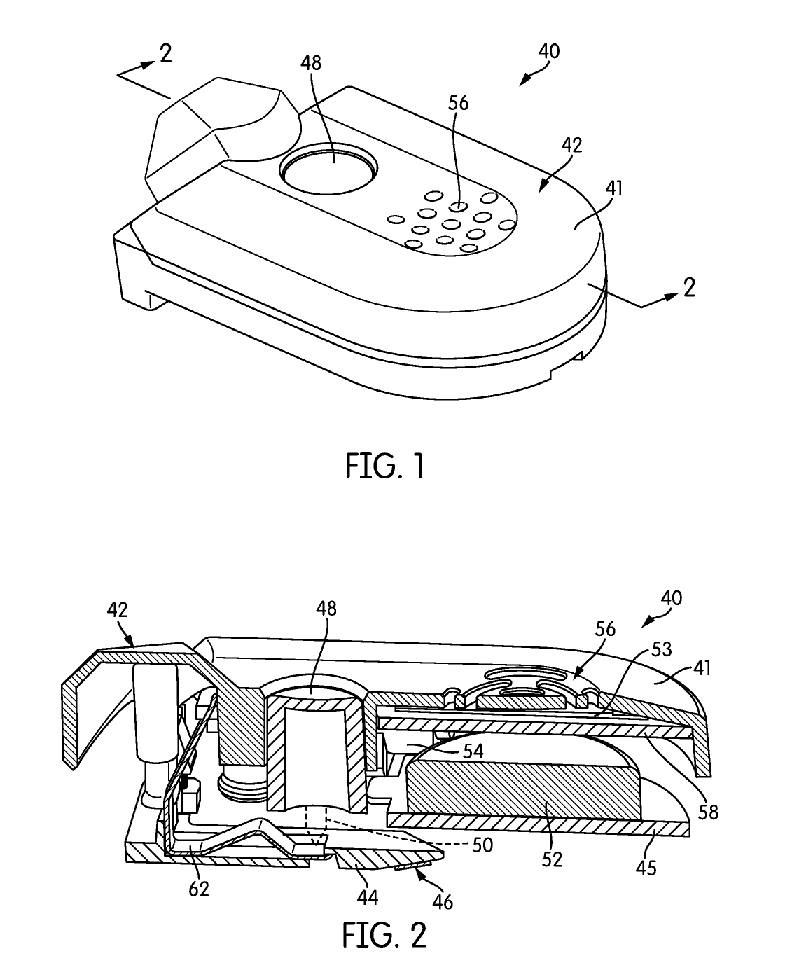

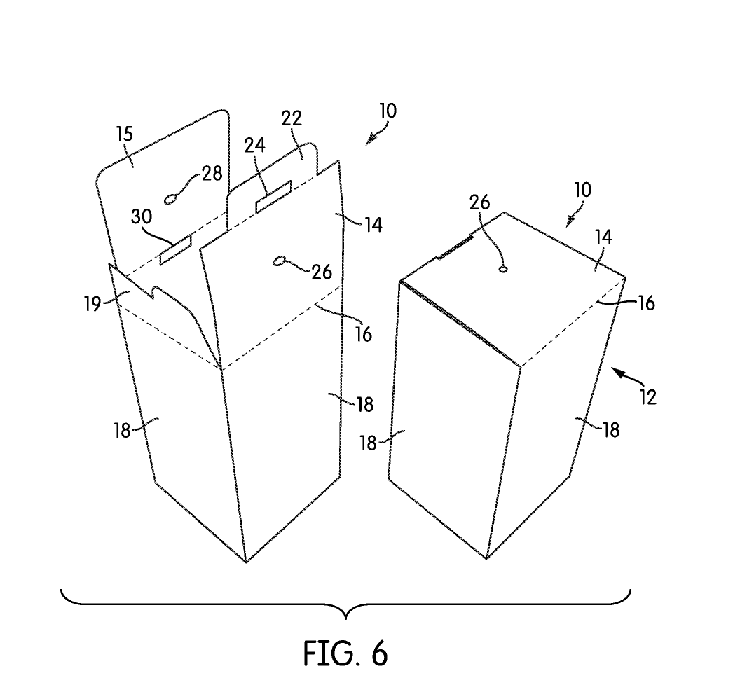

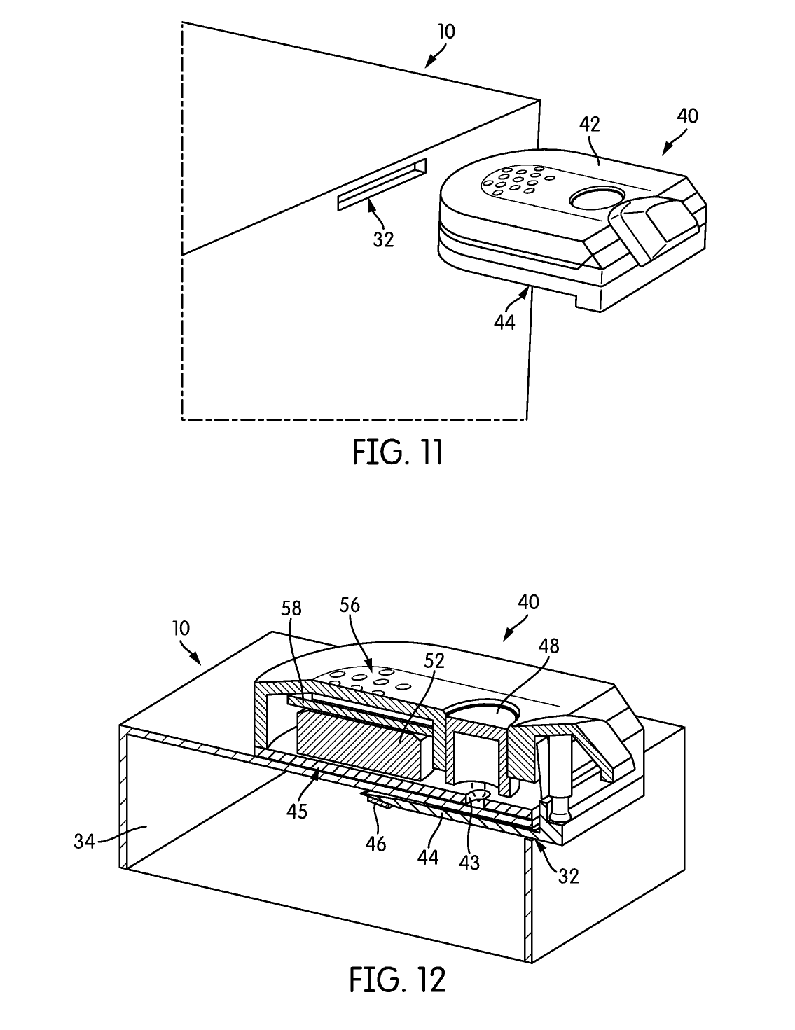

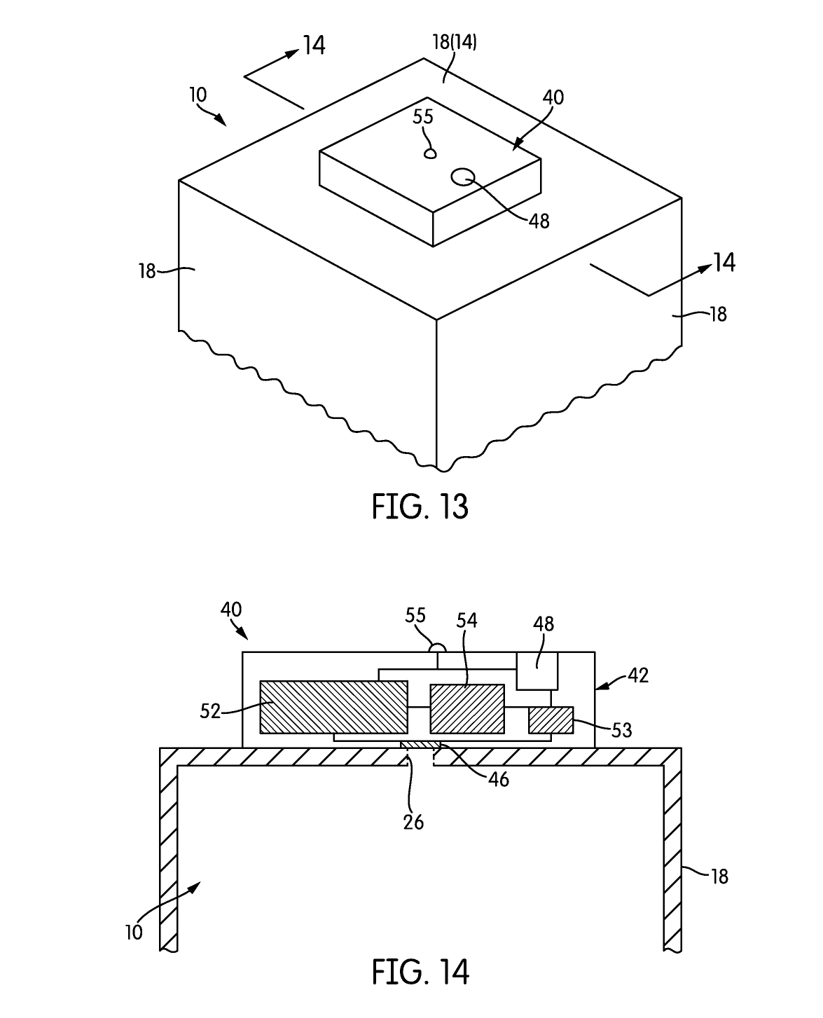

FIG. 1 illustrates a top perspective view of a security tag 40 in accordance with an embodiment of this disclosure. FIG. 13 illustrates a top perspective view of a schematic of another security tag 40 in accordance with an embodiment of this disclosure. A security tag 40 is adapted to cooperate with a product package, case, or container. The security tag is removably connected to the product package, e.g., product package 10 in FIGS. 6-12. In an embodiment, the security tag 40 is adapted to be removably attached to a product package 10. In an embodiment, at least a portion of the security tag 40 is adapted to be removably inserted into or through a predetermined opening in the product package 10. For example, as shown in FIG. 11, a part of the security tag 40 can be adapted to be aligned with and removably inserted into aligned openings 24 and 30 of the product body 12 and lid 14, as further described later. The security tag 40 can secure the product container 10 in a closed arrangement. In an embodiment, such as shown in FIG. 12, for example, an attached or secured security tag 40 can substantially prevent access to contents within a product package or container by assisting in securing one wall (e.g., lid) to another wall (e.g., side wall).

The security tag 40 includes: a housing 42 (see FIG. 1) having a top surface 41 and a bottom surface 45. The top and bottom surfaces 41, 45 can be formed separately and attached together (e.g., snap-fit). The top and bottom surfaces 41, 45 secure parts of a sensing system therebetween.

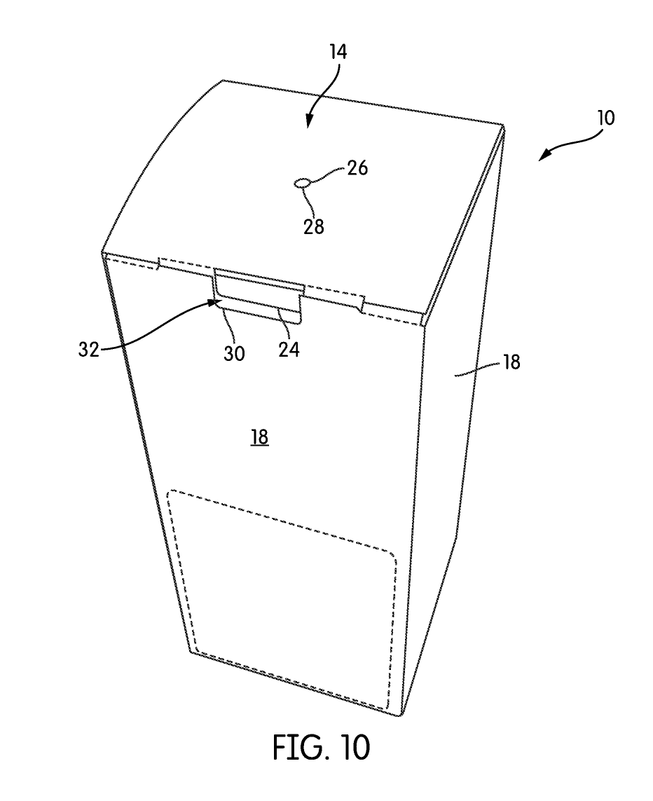

The security tag 40 includes a sensing system therein. The sensing system comprises at least one optical sensor 46. Optical sensor 46 can be provided on a lower side or underside of it housing 42. As shown in the embodiments herein, for example, the optical sensor 46 is positioned to face downwardly from the housing, into a package. The optical sensor can be aligned with an aperture or opening(s) in the package to detect light (ambient radiation) within its interior. For example, it can be positioned adjacent to a hole 26 or 28 (or when they are aligned) in the lid 14 or portion 15 or wall 18 of the package 10 (see FIG. 10 and/or FIG. 14). The optical sensor can also or alternatively be inserted into the package to detect ambient radiation therein.

In an embodiment, an elongate arm 44 (see FIG. 2 and FIG. 11) extends outwardly from the housing 42 of the security tag and is spaced therefrom. The elongate arm 44, or “arm,” can be mounted within or attached to the housing 42, or formed integrally therewith. As shown in FIG. 2, the arm 44 can extend in a parallel direction relative to the housing 42 (e.g., both the housing and arm extend in a longitudinal direction). The arm 44 is spaced relative to an underside of the bottom surface 45 such that when arm 44 is inserted into a package, a wall or lid of the package is received in the space. The arm 44 is configured for at least partial insertion into a package (see FIG. 12). The spacing between the arm 44 and bottom surface 45 can be determined based on the thickness of material(s) used for packages, since at least a portion of a wall of a package will be received in the space.

In an embodiment, the arm 44 is positioned for insertion into a predetermined opening or area of a package. In an embodiment, the arm 44 can have a pointed end (see FIG. 2) to pierce through shrink wrap or other materials around the package as it is entered or forced into the package interior.

The term “arm” is not intended to be limiting, and can also be called a leg, for example.

In accordance with an embodiment, as shown in FIG. 2, the optical sensor 46 is provided on the arm 44.

At least a portion of the arm 44 is designed for insertion into the package such that the optical sensor 46 is provided within the interior or interior cavity of the package for its detecting. In an embodiment, the optical sensor 46 is provided on an underside of the arm 44 when the security tag 40 is attached to a lid of the product package. The area for and method of mounting the security device and/or the optical sensor 46 should not be limiting.

In an embodiment, the at least one optical sensor 46 is covered or enclosed via a sensor window or exterior surface. The sensor window may comprise a translucent or transparent member for allowing radiation to pass therethrough while preventing inclusion of dust and/or particles from within the package. The window or surface can be substantially flush or flush with a surface of the housing 42. Alternatively, at least part of the optical sensor 46, such as its window or exterior surface extends from the housing 42. In an embodiment, the sensor 46 is applied to an outside of the housing 42.

The “optical sensor,” also called an electro-optical sensor, is an electronic detector that converts light, or a change in light, into an electronic signal. The optical sensor 46 is configured to detect and determine an intensity of ambient radiation it receives within the walls of the package, if there is any. For example, ambient light may enter the package (e.g., through an edge, wall, window, or opening of the package) and deflect off of the walls and/or bottom and/or product within the package, and the reflected radiation is received by optical sensor 46. More specifically, it is designed to detect ambient radiation within the package from an environment outside the package and/or from a source outside the package. Once inserted into a package and activated (further described below), the optical sensor 46 is calibrated according to the detection of ambient radiation within the package upon its activation. The intensity of the ambient radiation received by the sensor 46 corresponds to an amount of ambient light detected within the package, e.g., from an outside source (if any). The optical sensor 46 is configured to detect predetermined changes of intensity of the ambient radiation within the package after its initial calibration. If a predetermined change is detected, e.g., a predetermined change in an amount of intensity from its initial calibration, or alteration of the light level in the package (some light may seep into the package or box through an aperture for the tag, or gaps in the box), it can optionally activate an alarm or indicator of the security tag 40 to provide an alert.

The predetermined changes in intensity detected by the optical sensor 46 refers to a predetermined difference (e.g., delta) in the amounts of the intensity readings, when changed (e.g., determined by the optical sensor, or, in some cases, a controller). This is to compensate sudden fluctuations in light intensity do not need to trigger an alarm or alter, such as to compensate for shadows or changes in lighting. Further, the predetermined changes can further be associated with a period of time, e.g., the rate at which the intensity readings change. For example, if the time period for detecting a change in intensity is small, e.g., less than two seconds, the sensing system can be designed to compensate for such changes before activating an alert.

The predetermined change in intensity can result in tampering with the package or the product within the package itself. For example, when any point on the package and/or one of its walls is moved, opened, ripped, and/or broken, the resulting change in the radiation or light is detected by the sensor (e.g., detection of an increase of light therein). Further, removal of a product from the package will change the amount of ambient radiation detected therein. Moreover, the predetermined change(s) can include if or when the security tag 40 itself is pulled or removed from its associated package. The optical sensor 46 and sensing system can detect this also, because moving, opening, tearing, ripping, and/or breaking the package and/or security tag 40, and thus its optical sensor 46, at any point on the package can increase the light level or radiation detected by the sensor, whether when it is facing an adjacent opening/within the package interior or an outside environment. Optionally, the sensing system of the security tag 40 can trigger the alarm or indicator.

Accordingly, the security tag as disclosed herein guards against product removal from within the package, tag removal from the package, and the packaging walls, lids, etc. itself being physically interfered with.

The optical sensor 46 may be any type of sensor for detecting intensity of radiation. One known example of this type of sensor may include, but should not be limited to, photodetectors, phototransistors, or photoconductors.

A controller and/or processor (e.g., microcontroller and/or microprocessor) is also provided in the sensing system of the security tag 40, hereinafter referred to jointly as a “controller.” In an embodiment, the controller is configured to control and/or provide instructions based on the determined intensity readings of ambient radiation within the package, as detected by the optical sensor. The controller is configured to control other devices based on the intensity of light that is detected and any predetermined changes in the detected intensity, e.g., to trigger or activate an alarm.

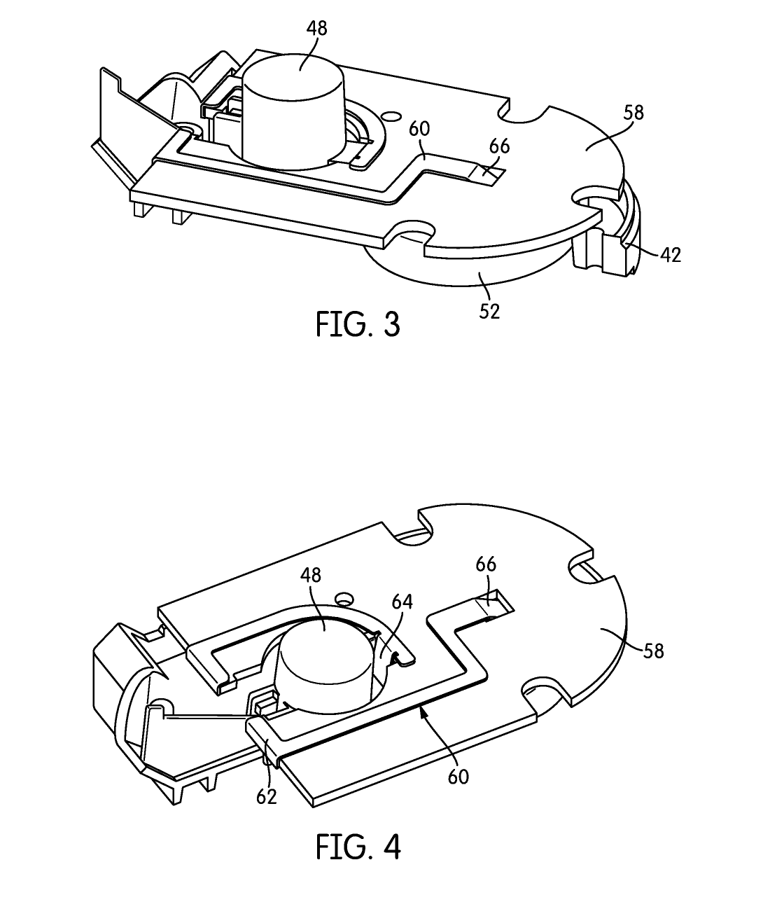

A circuit 60, shown in greater detail in FIGS. 3 and 4, is also provided in the tag 40. The circuit 60 is configured to connect a battery 52 within the housing 42, an alarm 54 or indicator 55 (see FIG. 13), and the optical sensor 46 such that the optical sensor 46 is activated for detection. That is, the circuit 60 is a connection circuit with spring electrical contacts that is formed and attached to a housing portion or plate 58 encapsulated in the housing 42. The battery 52 can be positioned near the bottom side 45 of the security tag 40, for example. The battery 52 can be positioned below the plate 58.

The circuit 60 has spring electrical contacts in the form of spring arm(s) 62, a connector arm 64, and attachment arm 66 (e.g., made of formed spring steel). Spring arm 62 is provided below the plate 58, as seen in FIG. 2. The spring arm 62 connects to optical sensor 46 on the arm 44. FIG. 12 shows the connector arm 64 of the circuit. The connector arm 64 extends downwardly through an opening in the plate 58, seen in FIG. 4. The connector arm 64 is configured for movement and contact with the battery 52 when the circuit/sensing system is activated (e.g., via activation button 48, described below). As the activation button 48 is pushed (e.g., downwardly), for example, the body of the button 48 moves the connector arm 64 towards and in contact with the battery 52. As shown in FIG. 10, the attachment arm 66 extends downwardly through an opening in the plate 58 to attach to a control board 53 provided on a top side of the plate 58. Throughout this disclosure, the control board 53 is also referred to as the “controller.” Once the sensing system is activated, the battery 52 supplies power to the circuit 60 and to the alarm 54 also found in the security tag 40. The alarm 54 can be associated with the control board 53 or controller, or added as a separate device within the housing 42 (e.g., see FIG. 2).

The associated alarm 54 or indicator 55 is adapted to provide an alert when a predetermined change in intensity is detected or determined using optical sensor 46. Put another way, when the sensing system (optical sensor 46 and controller 53) detects if a wall has been broken, or a lid opened, or some other event that results in a predetermined amount of change in ambient radiation or light levels, such as by a thief tampering with the product package 10 or other unauthorized entry, an alarm or indicator is triggered. In accordance with an embodiment, when the controller 53 detects a predetermined change in intensity (e.g., a substantial increase in the amount of light or ambient radiation), a radio signal can be sent to indicate the detected change, and/or an audible tone or similar sound may be optionally emitted by the alarm 54. Unauthorized removal of the security tag 40 from the product container assembly also activates the associated alarm or indicator.

The type of alarm 54, indicator 55, or alert that is activated by the controller 53 is not intended to be limiting. A sound, light, or other visual or hearing aid or notification need not be emitted by the security tag 40 upon detection of possible unauthorized entry. That is, although an alert or determination of tampering may be locally determined and locally activated via the controller, the alarm or indicator can be either locally emitted or remotely emitted, or both. As an example, a whistle option can be provided in the form of a signal (e.g., radio signal) that can be sent wirelessly to another device, e.g., system, computer, phone, tablet, etc., to alert an authorized person, e.g., supervisor, manager, owner, guard, etc. of the detection. For example, when a security tag detects tampering, a wireless signal can be sent and received by a remote computer system that in turn sends an alert to another remote device of a user or person, e.g., send a text message to a personal phone, pager, or tablet of a security guard in a store containing the product package.

In an embodiment, the emitted sound can be a locally emitted sound, e.g., through an audio device such as a speaker (e.g., see speaker holes 56 in FIG. 1). In an embodiment, the emitted sound can be remotely activated and emitted. For example, the security tag 40 may include a communication device (e.g., for wireless communication with another device) that is configured to activate an alarm in a store or a retail environment.

In an embodiment, in addition and/or alternative to the audible alarm, an indicator may be activated. For example, a light may be activated. FIG. 13 illustrates an example of an indicator 55 in the form of a light on the housing 42 of the security tag 40. In another embodiment, an indicator may be remotely activated (e.g., on a screen, on a mobile device, etc.).

Additionally and/or alternatively, it is contemplated that the alarm 54 may also detect an electric signal broadcast by the retail location (e.g., remote activation), such as a radio signal or WiFi protocols. The alarm 54 may emit an audible tone or sound (e.g., through its speaker 56) if the electric signal broadcast by the retail location sends instructions to do so.

Accordingly, it should be understood that a “security device” as used throughout this disclosure refers to at least a device associated with an optical sensor and an alarm or indicator and configured to activate an alarm or indicator when the optical sensor detects a predetermined change in the amount of detected ambient radiation within a package.

As previously noted, the security tag 40 further includes the activation button 48 for activating the circuit connection between the battery 52, the optical sensor 46, and the alarm 54. The activation button 48 can further deactivate the circuit connection, if already activated. FIG. 1 shows a top portion of the button 48 with a contact surface that is accessible for pushing (e.g., downwardly) towards arm 44. The pushing of the button 44 activates the sensing system within the security tag 40. Typically the security tag 40 can be attached to a package and then further secured and activated via pushing of the button 48.

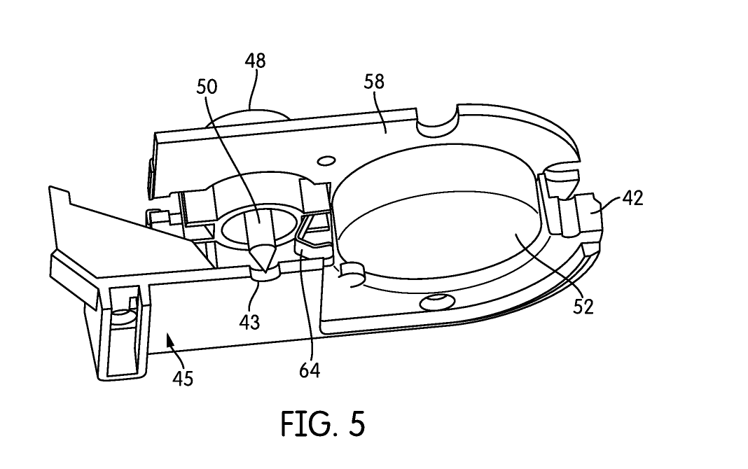

In accordance with an embodiment, the button 48 comprises a pin 50 extending from its body, as seen in FIG. 5, for example. The pin extends perpendicularly from the contact surface (from its bottom) towards the arm 44. The pin extends perpendicularly to the arm 44 as well. The pin 50 is designed to be pushed through an opening 43 in the bottom surface 45 of housing 42 to contact the arm 44 on an opposite side, for example. The pin 50 is secured by being locked with the arm 44. Thus, the pin 50 secures the security tag 40 to the package. The pin is also designed for contact with/movement of the arm 44 to connect and activate the circuit 60 of the security tag 40, which is described below.

The button 48 and pin 50 are designed for insertion through a wall in a package. For example, the pin 50 can be formed with a pierced end to pierce the wall or lid of the package and/or any shrink-wrap or covering of the package. In an embodiment, the location of the button 48 and/or pin 50 extending therefrom in the security tag 40 is designed based on a location of an opening in a package. For example, a hole can be formed in a lid of a package (e.g., see FIG. 10) for receiving pin 50 therethrough. The security tag 40 cannot be removed by accident since the pin is secured and holds it in place. Therefore, unauthorized removal of the security tag from the product package activates the alarm or indicator, e.g., if the device or the wall(s) are torn. The predetermined opening or hole or aperture in the product package can also help in the positioning of the security device itself onto the package.

The pin 50 is also inaccessible from the exterior of the product container 10 making it difficult, if not impossible, for a potential thief to open the package, or to remove a product from the package, without damaging the package walls or lid and/or the security tag 40 itself.

As seen by viewing the cross-sectional view in FIG. 2, in use, the pin 50 from the housing can be pushed down (e.g., via a button 48 or push point) into the package (e.g., into another optional opening, such as after insertion of its arm 44 into a predetermined opening, or through a wall of the package). In addition to locking the security tag 40 in place on a package, movement (e.g., pushing) of the button 48 and its pin 50 acts in effect as an ON/OFF switch for the security tag 40. For example, as previously noted, downward movement of the button 48 can cause one or more spring electronic contacts (e.g., a first electrical contact, e.g., connector 44, and/or a second electrical contact, e.g., spring arm 62) to connect with battery 52. This also adds an advantage in that it allows for conservation of power relative to the security tag in that, when it is not in use, it is turned off, resulting in a longer lasting life of the security tag.

Thus, a method for operating the security tag 40 can include attaching the security tag to the package, e.g., via optionally aligning and inserting the arm 44 of the security tag 40 into the package (e.g., through an opening, predetermined or not), and then activating the optical sensor 46 by connecting the battery 52 and the optical sensor 46 via the circuit 60, by pushing the button 48 and locking the pin 50 to the arm 44. Then, the ambient radiation within the package is determined with the sensor 46, including its intensity. The optical sensor 46 is then calibrated to the determined ambient radiation within the package. The optical sensor is configured to detect changes of intensity of the ambient radiation within the package to determine and optionally activate, via the controller, the alarm or indicator and provide the alert. When necessary, e.g., upon detection of an increase in the intensity of the ambient radiation using the optical sensor 46, the alarm is activated.

Accordingly, despite the configuration of the security tag, even if it does not lock the package, its connection to the package can stop a package from being opened or its product from being taken by operation of an alarm from the connected security tag, because breaking any point of the package can increase the light or radiation therein and triggers the alarm. Further, movement of or removal of the security tag relative to its associated package, or removal of product contents within the package, may also result in a change in intensity that triggers an alarm or indicator.

The security device 40 can be used with any number of types of packages. For example, in an instance where a package is formed from transparent or translucent materials, and/or includes an (optional) opening or window (example described below), the optical sensor 46 is designed to first calibrate itself according to detected ambient radiation within (or around) the package, received through the opening or window or walls. The sensing system then detects any [reflected] ambient radiation with the optical sensor 46, and determines its intensity.

Furthermore, a printed circuit board (PCB) and/or pin locking mechanisms can be used in accordance with an embodiment. Also, in embodiments, a security device can carry a transponder associated with an electronic article surveillance system (EAS) as used in retail environments (e.g. AM, RF, EM, or RFID).

In embodiments, the sensing system of the security device may use any sort of circuitry, software, logic, or a combination thereof to determine the intensity readings of the ambient radiation within the package. For example, in an embodiment, the controller comprises logic which determines any change in the detected level of intensity of the ambient light or radiation over a period of time. Thus, if a decrease or an increase in intensity of the ambient radiation is determined, a decrease or increase in the amount of ambient radiation in the package is detected. For example, when using photodetectors as optical sensors 46 to receive ambient radiation, a change in intensity is directly proportional to the amount of light within the package. Specifically, an increase in the intensity of the reflected radiation corresponds to an increase in the amount of ambient light within the interior or interior cavity of the package.

The circuit used with the sensing system is not intended to be limiting. In an embodiment, in order to ensure that sudden fluctuations in light intensity do not trigger the alarm 54, the circuitry can be designed with a stabilizer. In addition or alternatively, the controller may use logic and calculations to compensate for shadows, changes in lighting, or other known events that may occur that may affect the amount of ambient light received within the package and that is reflected and/or detected by the at least one optical sensor 46.

Thus, the security tag 40 offers numerous anti-theft features for a package. The security tag 40 may assist in keeping the product container locked in a closed orientation. The security tag 40 may trigger an alarm if the optical sensor 46 within the product container has detected a predetermined amount of change in the detected intensity therein, indicating that a portion of the package is broken and/or that an attempt has been made to open the product container.

The security tag 40 is adapted to be reused once the product initially placed in a package is sold to a consumer. A merchant can remove the security tag 40 from the package or container, for example, and may then insert it into in another product package, that is placed on a shelf in the retail environment.

The security tag 40 is also capable of being used in product containers of different sizes. For instance, it is contemplated that in an embodiment the security tag 40 may initially be utilized with a product container for a small electronic device, such as an MP3 player, and then later placed into a product container for a larger electronic device, such as a navigation system.

The size of the security tag 40 may vary based upon the size of the packaging and the type of product being secured.

Also, features of the security tag 40 can vary as well. For example, an arm 44 does not need to be provided on the tag 40 for securement of the tag 40 to a package or container. In an embodiment, as shown in FIGS. 13 and 14, the security tag 40 is configured for attachment using another device, including, but not limited to, stickers, glue or adhesive, magnets, or other attachment methods. As described above, the security tag 40 can include a housing 42 with an optical sensor 46, button 48 (optional), battery 52, controller 53, and an alarm 54 (optional) and/or indicator 55 (optional) that are connected and in communication with each other when the security tag 40 is activated. The optical sensor 46 can be aligned on a wall (e.g., wall 18 or lid 14) of a package 10 based on a location of a hole 26 therein, such that optical sensor 46 is positioned to calibrate and read light levels inside the package 10, as previously described.

FIG. 6 shows an exemplary product package 10 in the form of a box (e.g., made of paperboard) that can be configured to receive a security device 40 as disclosed herein. FIG. 10 illustrates an alternate side of the assembled product package 10. Product package 10 has a base or body portion 12 formed with a plurality of side walls 18 and a bottom 20, the side walls 18 generally extending upwardly or vertically from the bottom 20, and a lid portion 14 connected by a (living) hinge portion 16 to at least one side wall 18.

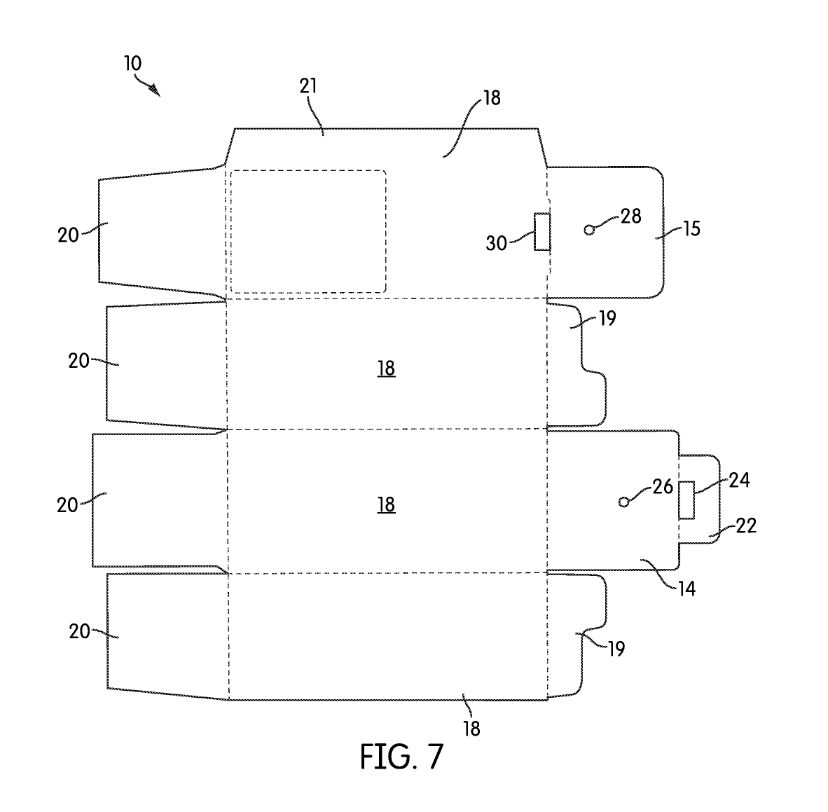

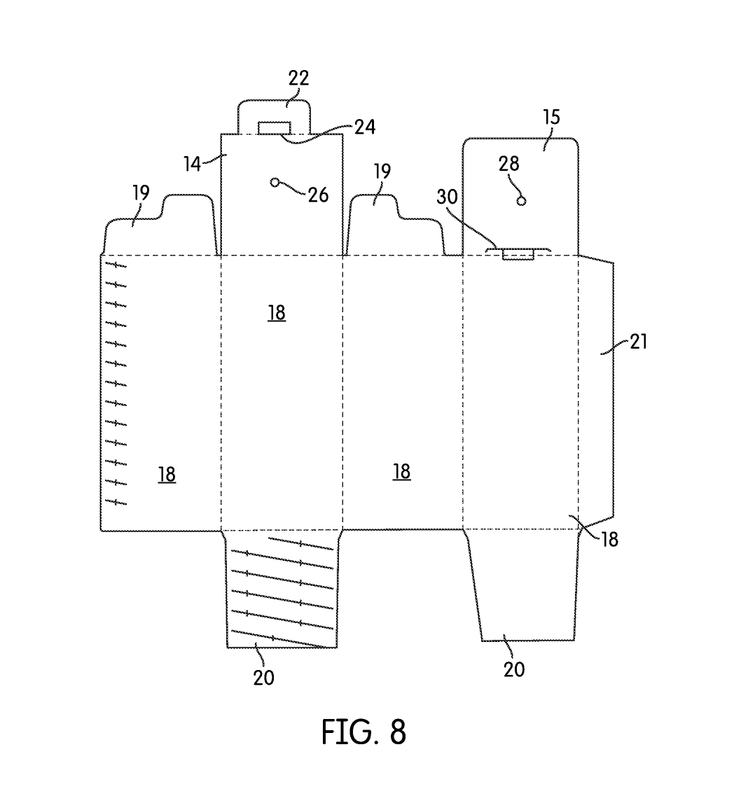

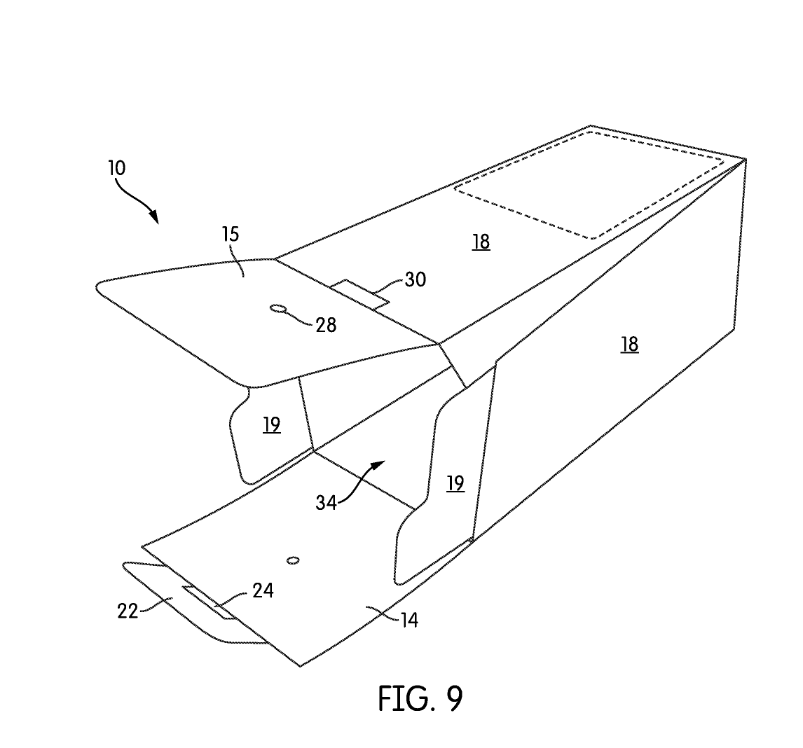

FIGS. 7 and 8 show a blank that can be used to form the box 10. Specifically, FIG. 7 shows exterior surfaces and FIG. 9 shows interior surfaces of each of the walls. The blank is formed with the plurality of sidewalls 18, a top wall 14 with a tab 22, tabs 15 and 21, and a plurality of flaps 19 and 20, each of which are designed to be folded along fold lines (shown as dashed lines) to form a package or enclosure with an opening for placing contents into its interior cavity 34 (also referred to herein as its “interior”).

The lid 14 as shown in FIGS. 6 and 9 moves between open and closed positions. Tab 15 is designed to be folded about its hinge, and the lid 14, which forms the top wall, also folds about its hinge 16 (after folding tab 15 and flaps 19 inwardly). At least a top wall 14 is pivotally attached to at least one other wall (e.g., a sidewall 18) to move between open and closed positions. When top wall 14 and (optional) tab 15 is open relative to the assembly, for example, e.g., see FIG. 9, it allows access to contents in the product package via an opening formed by side walls 18, and, when closed, it substantially prevents access to the contents therein.

Extending from one of the sidewalls 18 (e.g., rightmost sidewall, as shown in FIG. 8) is a tab 21 for attachment to another sidewall 18 (e.g., leftmost sidewall) when the box is assembled. For example, adhesive or glue may be applied to an outer or exterior surface of the tab 21 and aligned with and attached to an interior surface of sidewall 18. Also, one or more sidewalls 18 may further include flaps 19 and/or 20 attached thereto. Flaps 19 and 20 can be moved to open or close off access to contents within the package. In an embodiment, the bottom wall 20 can be formed from multiple tabs. In one embodiment, as shown in FIG. 7, for example, each sidewall 18 includes a bottom flap 20 that is configured to be secured (e.g., via folding and/or with adhesive) to form the bottom of the product package 10. In another embodiment, as shown in FIG. 8, two tabs extend from side walls 18 for folding and attachment to form the bottom wall 20. In yet another embodiment, not shown, the bottom can be formed a similar manner to the lid 14, such that at least one portion is configured to fold and hinge and be secured (e.g., via another tab) relative to the walls 18. In still yet another embodiment, tabs 20 can be provided in addition to a bottom wall 20 (or bottom lid), and used in a similar manner as tabs 15 and 19, for example.

Optionally, the product package further includes a number of score lines placed on the interior of any one of its walls, tabs, flaps, or lid. As shown in FIG. 8, for example, score lines can be provided on a wall 18 near a location that connects with tab 21 and/or on a bottom wall 20 or tab. Score lines do not necessarily need to extend all of the way through the substrate (from the interior to the exterior). Score lines can provide a built in weakness in the walls and assist in tearing of the same. That is, they can increase the probability that the printed circuit will be broken if the walls are torn or moved. Accordingly, when one or more score lines on one of the walls or tabs is severed, ambient radiation or light from outside can enter into the product package 10. Thus, the optical sensor 46 can detect the change of intensity of ambient radiation within the interior cavity, and a determination can be made if an alarm should be activated (or not).

The addition of score lines in addition to adhesive in such seam areas (bottom, side) encourages tearing if the walls are tampered with by enhancing a weakness in the area and helps ensure tearing of a wall or tab. The scoring lines may be in the form of lines, dashes, dots, notches, etc. and are not limited to the illustrated design. In an embodiment, the score lines comprise perforations.

In accordance with an embodiment, the housing 42 of the security device 40 is provided adjacent to and/or on top of the top wall 14 or lid. The product package 10 can be formed to accommodate its attachment. For example, in an embodiment, an aperture is provided (e.g., hole 26, hole 28, and/or both being relatively aligned) for positioning of the optical sensor 46 of the security tag 40 adjacently thereto such that the optical sensor 46 can detect intensity. In an embodiment, the security device 40 may be removably attached to a predetermined opening (e.g., receiving opening 32) on an outside of a product container or package.

In an embodiment, the product package 10 includes a tab 22 with an alignment opening 24 or hole that extends from the top wall 14 or lid and which is configured to align with a receiving opening 30 or hole on side wall 18 when the top wall 14 is moved or hinged to the closed position. The tab 22 is folded along its fold line and inserted into a receiving area formed by a slit that is cut in tab 22 near an edge and adjacent a fold line. That is, openings 24 and 30 are aligned when the product package is in the closed position, e.g., as shown in FIG. 10, and form the receiving opening 32. Tab 22 is adjacent sidewall 18 when inserted into the slit. Alignment opening 24 is aligned with receiving opening 30 in the closed position when assembled. This can assist in increasing the strength of the aperture designed to receive part of the security device (e.g., an arm 44 of the security device 40).

As shown in FIG. 11, the security device 40 is adapted to cooperate with the product package 10 in its assembled form via alignment with and subsequent insertion of its arm 44 through the aligned openings 34 and 30. In another embodiment, the receiving opening 32 is formed directly a wall, e.g., side wall 18. For example, opening 30 can be used alone without opening 24 in the tab.

Further, to secure or lock the security device 40 to the closed box or package, a pin receiving hole can be provided. In the illustrated embodiment, for example, the pin receiving hole can be punched in the top so that it allows a pin from a security device to be inserted therethrough and locked with an arm or button underneath the top of the package. In an embodiment, to secure or lock the security device 40 to the top of the closed box or package, the top wall 14 can include a through hole 26 for receipt of the pin 50 of the security device 40. In an embodiment, tab 15 also includes a through hole 28 that is positioned such that, when tab 15 and top wall 14 are folded about their hinges to a closed position, the through holes 28 and 26 align with each other to form a pin receiving opening.

Accordingly, after insertion of the arm 44 of the security device 40 through receiving opening 32, the pin 50 can be moved or pushed (e.g., via button 48) through the aligned holes 26 and 28 and locked with arm 44 to hold it in place. FIG. 12 illustrates an example of this attachment. Pressing of the button 48 (e.g., downwardly) so that its pin 50 moves through the aligned holes 26 and 28 enables contact between the pin 50 and arm 44/sensor 46. Further, as previously described, it electrically connects the circuit 60 by moving the connector 64 into contact with the battery 52 (see FIG. 5). As shown in FIG. 12, then, the optical sensor is positioned to face downwardly into the interior cavity 34, the interior cavity being provided below the optical sensor (on arm 44).

The security device cannot be removed by accident since the pin holds it in place. Therefore, unauthorized removal of the security device from the product package can activate the alarm or indicator. The hole also helps the positioning of the device itself. The location of the pin receiving opening can be based on the location of the pin of the security device to be attached, for example.

It is noted that the location and the exemplary illustration of the openings and the positioning of the security device on the top wall, as shown, is not intended to be limiting.

In an embodiment, openings for insertion of the arm 44 and/or pin 50 may not need to be provided. The security device can additionally and/or alternatively be adapted to cooperate with the product package via insertion through other aligned openings.

Although not shown, the product package 10 can further include a hanging tab with an opening for hanging on a display. In an embodiment, the opening for hanging can be formed in a wall, e.g., in a side wall 18.

In an embodiment, exterior surfaces of one or more of the walls may include stickers, labels, or other product markings thereon. In an embodiment, a display opening is provided that can be used to allow scanning or reading of a bar code, for example.

In an embodiment, at least one window may be provided in one or more walls of the package 10 (e.g., see dashed lines on side wall 18 in FIGS. 7, 9, and 10). In an embodiment, the window may be formed from material that is substantially translucent or transparent or, alternatively, comprise a through opening. The at least one window permits ambient light constituting ambient radiation to enter the package 10. The window (or opening) may also allow a user to view the contents within the package 10. The window permits light to be directed into the interior cavity 34 of the package 10. Ambient light can enter from a plurality of directions and be reflected off of any product or contents in the interior as well as the interior of the walls 18. The sensor system of the security device 40 can be calibrated based on the ambient radiation that enters the package via the window, e.g., when positioned or hanging on a display rod or shelf.

In another embodiment, one or more of the walls 18, 20, and/or lid 14 are formed from substantially translucent or transparent material. In a similar manner, the security system can be calibrated based on the light therein.

The manufacture of product containers or packages shown herein is not meant to be limiting. A lid and a base made be formed using any number of techniques. Packages made from a paper based material, such as paperboard, cardboard, and the like, to form a box or similar shape, or two sided container, can be manufactured as a generally flat sheet, or “blank,” that can be designed to be folded together, and can optionally utilize flaps, tabs, adhesives, and/or adhesives in order to make the generally flat sheet into a product container. However, it should be noted that the product package 10 may be made from a variety of materials including polymeric materials, paper, paperboard, cardboard, plastics, thermoplastics, and the like. The security tag 40 allows materials such as paper, paperboard, and cardboard, etc. to be utilized—alone or in combination—even with more expensive products or contents therein, as the alarm 54 of the security tag 40 will activate if the product package 10 is tampered with in an effort to remove its content, reducing the likelihood of a thief stealing the contents of the product container 10.

The illustrated embodiments described herein are not meant to be limiting. Accordingly, it is in accordance with an embodiment herein to provide a security tag. One aspect of the disclosure provides a security tag. The security tag for a package comprising: a housing with a battery therein; an optical sensor on the housing configured to detect an intensity of ambient radiation within the package; a circuit connecting the battery and the optical sensor; an alarm or indicator further connected to the circuit and adapted to provide an alert; and a controller configured to control the alarm or indicator based on detections by the optical sensor, wherein the optical sensor is calibrated upon attachment of the housing to the package based on ambient radiation detected within the package, and wherein the optical sensor is configured to detect the changes of intensity of the ambient radiation within the package to activate via the controller the alarm or indicator and provide the alert.

In an embodiment, this disclosure provides a security tag that includes: a housing with a battery therein and an arm extending from the housing and spaced therefrom. The arm is configured for insertion into a package. An optical sensor is provided on the arm and configured to detect an intensity of ambient radiation within the package. A circuit is also provided in the tag and is configured to connect the battery and the optical sensor such that the optical sensor is activated for detection. An alarm or indicator is connected to the circuit and adapted to provide an alert. A controller is configured to control the alarm or indicator based on detections by the optical sensor. The optical sensor is calibrated according to the detection of ambient light radiation within the package upon its activation, and is configured to detect the changes of intensity of the ambient radiation within the package after its calibration to activate via the controller the alarm or indicator and provide the alert.

It is in accordance with an embodiment to provide a product package with a security tag. The product package includes: a plurality of walls configured to contain contents in an interior cavity; at least one of the plurality of walls of the product package configured to be moved between (a) an open position allowing access to contents inside the interior cavity of the product package via an opening and (b) a closed position substantially preventing access to the contents within the interior cavity therein by closing the opening; and a security device being removably connected to the product package. The security device has a housing with a battery, and an optical sensor on the housing positioned and configured to detect an intensity of ambient radiation in the interior cavity of the product package. A circuit of the security device is configured to connect the battery and the optical sensor for detection. The security device further includes an alarm or indicator adapted to provide an alert. A controller is configured to control the alarm or indicator based on detections by the optical sensor. The optical sensor is calibrated according to the intensity detection of ambient radiation within the interior cavity of the product package upon its activation. The optical sensor is configured to detect a change of intensity of ambient radiation within the interior cavity after its calibration to activate the alarm or indicator via the controller and provide the alert.

In an embodiment herein, there is provided a method for operating a security tag attached to a package. The security tag has a battery, an optical sensor configured to detect an intensity of ambient radiation within the package, a circuit configured to connect the battery and the optical sensor such that the optical sensor is activated for detection, an alarm or indicator adapted to provide an alert, and a controller configured to control the alarm or indicator based on detections by the optical sensor. The method includes: activating the optical sensor by connecting the battery and the optical sensor via the circuit; determining the ambient radiation within the package with the sensor; determining changes in intensity of the ambient radiation; and calibrating the optical sensor to the determined ambient radiation. The optical sensor is configured to detect the changes of intensity of the ambient radiation within the package to activate the alarm or indicator via the controller and provide the alert.

The features described with respect to each of the embodiments herein are not limited to those designs for which they are shown. For example, tabs, flaps, openings or holes, fold lines, score lines, and the like may be provided on and/or removed from any of the embodiments described herein. The circuit for connecting the battery to the optical sensor for activation thereof can be provided within the housing in any number of ways. Any number of methods or materials can be used to form the housing of the security tag and the parts herein. Similarly, the product package, case, container, structure, or blank can be formed from any number of materials and in any number of methods.

A blank that is configured for assembly is not intended to be limited to the illustrated embodiments herein. Further, the assembly of the product packages should be understood by one of ordinary skill in the art. For example, in some embodiments, blanks of the different packages can be partially assembled or adhered together for assembly, but flattened so that they can be packed for shipping (i.e., before objects or contents are placed therein). Also, in some embodiments, packages can be assembled, a product placed therein, closed, and then secured with shrink wrap or a similar product. The security tag may be attached to a package (e.g., for alignment with an aperture, or through a predetermined opening) after the package with the product therein is shrink-wrapped. The optional arm can pierce the shrink wrap when inserted into the package (e.g., through the receiving opening). The pin of the button can pierce through the shrink wrap.

Furthermore, the use of a flat blank is shown herein as an example only and is not intended to limit the formation of the package. Packages and/or its parts can be molded or formed.

Moreover, it should be understood that the disclosure herein is not intended to limit use of the herein disclosed security tag to a new type of package or blank that needs to be manufactured. A security tag with features as disclosed herein that can attach to any pre-assembled product package by inserting its optical sensor into the interior is also within the scope of this disclosure. Additionally, openings can be formed in existing packages to accommodate attachment of the security tag (e.g., insertion of its arm with the optical sensor) to such devices.

The receiving opening for the arm with optical sensor thereon does not need to be specifically formed within a wall of the package. The receiving opening could already be formed in the package itself. It can be a portion of the package that provides access into its interior and that can receive the arm, e.g., a space between parts of the package walls or lid, or the arm could be inserted at a seam. Similarly, an aperture on the package for alignment with an adjacent optical sensor of the security tag need not be specifically formed on the package. For example, such an aperture may already exist in the package. Furthermore, an aperture need not be provided on the package for the positioning of the optical sensor to detect light. As previously mentioned, for example, at least one window may be provided in one or more walls of a package. The optical sensor can be positioned adjacent to such a window, and thus configured to detect ambient radiation within a package interior.

Moreover, the location for attachment of a security tag is not limited. Also, the placement of security tag onto the package does not necessarily need to be inserted at a point at or near the opening or closure of the package, but rather a point that allows for the positioning of the optical sensor to detect and calibrate (via the controller) in relation to radiation or light in its interior without departing from the scope of this disclosure, so that when any point on the package and/or one of its walls is moved, opened, ripped, and/or broken, the resulting change in the radiation or light is detected by the sensor (e.g., detection of an increase of light therein). When a predetermined amount or change of light is detected within the package, e.g., over a predetermined period of time, thereby resulting in a calculation or determination of unauthorized access or entry, the alarm or indicator associated with the security tag can be triggered.

It should be understood that the design and shape of the security tag as shown herein is not intended to be limiting, and that other shapes and/or designs, for example, may be implemented in a similar manner and still be within the scope of this disclosure. For example, a different security device may have similar features as security tag 40 (e.g., a battery, a processor, PCB, an alarm, pins, and/or an insert), along with an optical sensor for detecting ambient light or radiation within a package.

While the principles of the disclosure have been made clear in the illustrative embodiments set forth above, it will be apparent to those skilled in the art that various modifications may be made to the structure, arrangement, proportion, elements, materials, and components used in the practice of the disclosure.

It will thus be seen that features of this disclosure have been fully and effectively accomplished. It will be realized, however, that the foregoing preferred specific embodiments have been shown and described for the purpose of illustrating the functional and structural principles of this disclosure and are subject to change without departure from such principles. Therefore, this disclosure includes all modifications encompassed within the spirit and scope of the following claims.

What is claimed is:

1. A security tag for a package comprising:
a housing with a battery therein;
an optical sensor on the housing configured to detect an intensity of ambient radiation within the package;
a circuit connecting the battery and the optical sensor;
an alarm or indicator further connected to the circuit and adapted to provide an alert; and
a controller configured to control the alarm or indicator based on detections by the optical sensor,
wherein the optical sensor is calibrated upon attachment of the housing to the package based on ambient radiation detected within the package, and wherein the optical sensor is configured to detect the changes of intensity of the ambient radiation within the package to activate via the controller the alarm or indicator and provide the alert.

2. The tag according to claim 1, further comprising an activation button for activating the circuit connection between the battery and the optical sensor.

3. The tag according to claim 1, wherein the optical sensor is positioned to face downwardly from the housing.

4. The tag according to claim 1, wherein the optical sensor of the housing is configured for alignment with an aperture on the package.

5. The tag according to claim 1, wherein the housing further comprises an arm, the arm configured for insertion into a package, and wherein the optical sensor is provided on the arm.

6. A security tag comprising:
a housing with a battery therein;
an arm extending from the housing and spaced therefrom, the arm being configured for insertion into a package;
an optical sensor on the arm configured to detect an intensity of ambient radiation within the package;
a circuit configured to connect the battery and the optical sensor such that the optical sensor is activated for detection;
an alarm or indicator further connected to the circuit and adapted to provide an alert; and
a controller configured to control the alarm or indicator based on detections by the optical sensor,
wherein the optical sensor is calibrated according to the detection of ambient radiation within the package upon activation, and wherein the optical sensor is configured to detect the changes of intensity of the ambient radiation within the package after its calibration to activate via the controller the alarm or indicator and provide the alert.

7. The tag according to claim 6, further comprising an activation button for activating the circuit connection between the battery and the optical sensor.

8. The tag according to claim 7, wherein the button comprises a pin extending therefrom for locking with the arm.

9. The tag according to claim 8, wherein the pin extends perpendicular to the arm.

10. The tag according to claim 6, wherein the optical sensor is positioned to face downwardly from the housing.

11. A product package comprising:
a plurality of walls configured to contain contents in an interior cavity;
at least one of the plurality of walls of the product package configured to be moved between (a) an open position allowing access to contents inside the interior cavity of the product package via an opening and (b) a closed position substantially preventing access to the contents within the interior cavity therein by closing the opening; and
a security device being removably connected to the product package, the security device comprising a housing with a battery, an optical sensor on the housing positioned and configured on the product package to detect an intensity of ambient radiation in the interior cavity, a circuit configured to connect the battery and the optical sensor for detection, and the security device further comprising an alarm or indicator adapted to provide an alert and a controller configured to control the alarm or indicator based on detections by the optical sensor,
wherein the optical sensor is calibrated according to the intensity detection of ambient radiation within the interior cavity of the product package upon activation, and wherein the optical sensor is configured to detect a change of intensity of ambient radiation within the interior cavity after its calibration to activate the alarm or indicator via the controller and provide the alert.

12. The product package according to claim 11, wherein the optical sensor on the housing of the security device is positioned adjacent to an aperture on the product package.

13. The product package according to claim 11, wherein the security device further comprises an arm extending from the housing that is inserted into the product package, and wherein the optical sensor is provided on the arm.

14. The product package according to claim 13, further comprising a receiving opening within one of the plurality of walls of the product package providing access to the interior cavity, and wherein the arm is inserted through the receiving opening.

15. The product package according to claim 11, wherein the plurality of walls of the product package comprises at least a top wall that is pivotally attached to at least one other wall, the top wall being movable between the open position and the closed position, and wherein the housing of the security device is provided on top of the top wall.

16. The product package according to claim 15, wherein the optical sensor is positioned to face downwardly into the interior cavity, the interior cavity being provided below the optical sensor.

17. The product package according to claim 11, further comprising score lines placed on the plurality of walls, wherein a severed score line is configured to allow ambient radiation from outside enter into the product package, and wherein the optical sensor is configured to detect the change of intensity of ambient radiation within the interior cavity.

18. A method for operating a security tag attached to a package, the security tag comprising a battery, an optical sensor configured to detect an intensity of ambient radiation within the package, a circuit configured to connect the battery and the optical sensor such that the optical sensor is activated for detection, an alarm or indicator adapted to provide an alert, and a controller configured to control the alarm or indicator based on detections by the optical sensor; the method comprising:
activating the optical sensor by connecting the battery and the optical sensor via the circuit;
determining the ambient radiation within the package with the sensor;
determining an intensity of the ambient radiation; and
calibrating the optical sensor to the determined ambient radiation;
wherein the optical sensor is configured to detect the changes of intensity of the ambient radiation within the package to activate the alarm via the controller or indicator and provide the alert.

19. The method for operating the security tag according to claim 18, further comprising determining predetermined changes in intensity of the ambient radiation over a period of time using the controller.

20. The method for operating the security tag according to claim 18, further comprising activating the alarm upon detection of an increase in the intensity of the ambient radiation using the controller.
